(19) United States
(12) Patent Application Publication
(10) Pub. No.: US 2007/0093602 A1
(43) Pub. Date: Apr. 26, 2007

(54) Solid polyurethane compositions, infrastucture repair and geo-stabilization processes

(75) Inventors: James A. Thompson-Colon, Moon Township, PA (US); Jay A. Johnston, Pittsburgh, PA (US); Ashok M. Sarpeshkar, Upper Saint Clair, PA (US); John D. Hodel, Pittsburgh, PA (US)

Correspondence Address: BAYER MATERIAL SCIENCE LLC, 100 BAYER ROAD, PITTSBURGH, PA, 15205, US

(73) Assignee: Bayer MaterialScience LLC

(21) Appl. No.: 11/583,532

(22) Filed: Oct. 19, 2006

Related U.S. Application Data
(63) Continuation-in-part of application No. 11/257,226, filed on Oct. 24, 2005.

(51) Int. Cl. C08F 8/30

(52) U.S. Cl. 525/127

(57) ABSTRACT

The present invention provides processes for infrastructure repairs and geo-stabilization with a low-exotherm polyurethane foam, grout or elastomer. The inventive process involves at least partially filling a cavity in the infrastructure or earth with a low-exotherm polyurethane foam, grout or elastomer made from at least one polyisocyanate, at least one isocyanate-reactive compound and an organic particulate material capable of absorbing heat, optionally in the presence of one or more chosen from water, surfactants, pigments, catalysts, alkali silicates and fillers and curing the polyurethane foam, grout or elastomer. The inventive processes may improve the repair of buildings, foundations, roads, bridges, highways, sidewalks, tunnels, manholes, sewers, sewage treatment systems, water treatment systems, reservoirs, canals, irrigation ditches, etc.; and in the geo-stabilization of mines, caves, wells, bore-holes, ditches, trenches, pits, cracks, fissures, craters, postholes, potholes, sinkholes, wallows, waterholes and the like. The inventive solid polyurethane compositions are made from at least one polyisocyanate, at least one isocyanate-reactive compound, and an organic particulate material capable of absorbing heat, optionally one or more chosen from water, surfactants, pigments, catalysts and fillers. Such solid polyurethane compositions may improve reaction injection molding (RIM), spray elastomer and cast molding processes.

This Application is a Continuation-in-Part of U.S. Ser. No. 11/257,226, filed Oct. 24, 2005.

### FIELD OF THE INVENTION

The present invention relates in general to polyurethanes and more specifically to solid polyurethanes for use in reaction injection molding, spray and cast molding processes and to processes for infrastructure repair and for geo-stabilization with a low-exotherm polyurethane foam, grout or elastomer.

### BACKGROUND OF THE INVENTION

U.S. Pat. No. 4,567,708 issued to Haekkinen, teaches a method for leveling sunken or broken portions of earth-supported floors or slabs involving making at least one hole in the floor and spraying polyurethane foam between the floor and the underlying earth. The foam creates a mold pressure in the space, which raises the floor.

Andy et al., in U.S. Pat. No. 4,74,4700, disclose a method of completely filling mines and underground cavities in such a way as to reinforce the strata and ground there above to prevent collapse or subsidence. The method of Andy et al., involves the introduction into mines and cavities of expandable plastic materials which are incorporated into a chemically catalyzed foam reaction and strongly bonded thereby. A drawback to this procedure is that heat is required to expand foamable plastic materials and is provided by the chemically exothermic polymerization reaction of polymeric isocyanate with polyols and epoxides by basic catalysis which promotes highly exothermic urethane/isocyanurate polymer formation in the presence of suitable blowing agents and surfactants.

U.S. Pat. Nos. 4,827,005 and 4,871,829, both issued to Hilterhaus, teach organomineral products of high strength obtained by reacting a polyisocyanate in an aqueous alkali silicate solution in the presence of a catalyst prompting the trimerization of the polyisocyanate. The catalyst is used in an amount of 5.5 to 14.5 mmole per mole of NCO groups in the reaction mixture. The organomineral products of Hilterhaus are said to be suitable as construction, coating, sealing or insulating materials or as putty or adhesives.

Ferm et al., in U.S. Pat. Nos. 6,052,964 and 6,532,714, teach a method for restoring load transfer capability across a joint between two adjacent concrete slabs involving cutting a slot perpendicularly to the joint and extending into each of the adjoining slabs. The slot and joint are integrally filled with polymer concrete to tie the slabs together. A joint tie may be placed in the slot and encased by the polymer concrete when restoring load transfer capability.

U.S. Pat. No. 6,265,457, issued to Dolgopolsky et al., discloses an isocyanate-based polymer foam matrix having disposed therein a particulate material having an enthalpy of endothermic phase transition of at least about 50 J/g. The particulate material is said to act as a heat sink and undergo an endothermic phase change by absorbing a significant portion of the heat of reaction liberated during the process of producing the foam. This heat absorption is said to improve the safety of the process by lowering the maximum exotherm experienced by the foam. Dolgopolsky et al., limit their use of their particulate material to polyurethane foams, no suggestion is made of the suitability of such materials in solid polyurethane compositions such as those employed in reaction injection molding (RIM), spray elastomer or cast molding processes.

Grigsby, Jr., in U.S. Pat. No. 6,552,121, teaches a process for preparing alkali silicate-polyisocyanate composites without catalyst separation. The process involves blending a catalyst and a polyisocyanate to form a first component, and blending an alkali silicate and water to form a second component. The first and second components are mixed together to form a reactive mixture that reacts to form a hardened composite. The progression of the reaction is said to proceed without excessive foaming, high exotherms, or the release of an offensive odor. Sodium silicate-polyisocyanate composites prepared according to the process, and a process for using the alkali silicate-polyisocyanate composites to consolidate and seal various types of formations in mining, tunneling, and other construction projects are also disclosed therein.

U.S. Pat. No. 6,639,010, issued to Bode, teaches a method for the manufacture of elastic, fire resistant, organo-mineral systems based on water-glass (sodium silicate) in which, to the water-glass, compounds, having terminal amino groups are added, in which at least one free hydrogen atom on at least one amino group and at least one alkylene group interrupted by one oxygen and/or sulfur atom are present as well as the products and the two component systems which can be obtained therewith. The latter is said to be able to be applied in mining for filling and/or agglutination of anchors.

Van der Wal et al., in U.S. Pat. No. 6,849,666, teach a process for producing resilient polyurethane foams by foaming an organic polyisocyanate, an isocyanate-reactive compound and a fusible polymer. The improvement in the hardness of the foams is said to be achieved without adversely affecting the other properties of the foams, such as tensile strength and elongation.

WO 01/79321, in the name of Frick et al., teaches polyurethane foams with reduced exothermy which are used for hardening rocks in mining and underground engineering.

Infrastructure repairs and geo-stabilization typically occur in locations where the buildup of heat generated by a polyurethane-forming reaction is not only undesirable, but may be potentially dangerous. Furthermore, reaction injection molding (RIM), spray elastomer or cast molding processes would also benefit from a reduction in heat buildup. Therefore, a need exists in the art for processes for infrastructure repairs and for geo-stabilization which reduce the generation and accumulation of heat. A need also exists for compositions suitable for use in reaction injection molding (RIM), spray elastomer or cast molding processes which would reduce the generation and accumulation of heat.

### SUMMARY OF THE INVENTION

Accordingly, the present invention provides processes for infrastructure repair and for geo-stabilization with a low-exotherm polyurethane foam, grout or elastomer. The present invention also provides solid polyurethane compositions useful in reaction injection molding (RIM), spray elastomer or cast molding processes. The inventive infrastructure repair and for geo-stabilization processes involve at least partially filling a cavity in the infrastructure or in the earth with a low-exotherm polyurethane made from at least one polyisocyanate, at least one isocyanate-reactive compound, an organic particulate material capable of absorbing heat, optionally in the presence of one or more chosen from water, surfactants, pigments, catalysts, alkali silicates and fillers and curing the polyurethane foam, grout or elastomer. Because the instant infrastructure repair and for geo-stabilization processes utilize low exotherm polyurethane foams, grouts or elastomers, heat accrual is a greatly reduced concern. The inventive solid polyurethane compositions are made from at least one polyisocyanate, at least one isocyanate-reactive compound, and an organic particulate material capable of absorbing heat, optionally one or more chosen from water, surfactants, pigments, catalysts and fillers. Such solid polyurethane compositions may improve reaction injection molding (RIM), spray elastomer and cast molding processes.

These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the figures, wherein:

FIG. 1 shows temperature profiles for foams containing various amounts of a polyethylene as the organic particulate material;

FIG. 2 depicts temperature profiles for water-blown foams containing various amounts of a copolymer of ethylene and butene-1 as the organic particulate material;

FIG. 3 illustrates temperature profiles for water-blown foams containing sodium silicate and various amounts of a copolymer of ethylene and butene-1 as the organic particulate material;

FIG. 4 shows the temperature profiles for solid cast molded compositions of the invention;

FIG. 5A shows a reaction injection molded parts made without an organic particulate; and

FIG. 5B shows a reaction injection molded parts made with an organic particulate.

### DETAILED DESCRIPTION OF THE INVENTION

The present invention will now be described for purposes of illustration and not limitation. Except in the operating examples, or where otherwise indicated, all numbers expressing quantities, percentages, OH numbers, functionalities and so forth in the specification are to be understood as being modified in all instances by the term “about.” Equivalent weights and molecular weights given herein in Daltons (Da) are number average equivalent weights and number average molecular weights respectively, unless indicated otherwise.

The present invention provides an infrastructure repair process involving at least partially filling one or more cavities in the infrastructure with a low-exotherm polyurethane foam, grout or elastomer made from at least one polyisocyanate, at least one isocyanate-reactive compound and at least one organic particulate material capable of absorbing heat, optionally in the presence of one or more chosen from water, surfactants, pigments, catalysts, alkali silicates and fillers, and curing the low exotherm polyurethane foam, grout or elastomer.

The present invention also provides a geo-stabilization process involving at least partially filling an earthen cavity with a low-exotherm polyurethane foam, grout or elastomer made from at least one polyisocyanate, at least one isocyanate-reactive compound and at least one organic particulate material capable of absorbing heat, optionally in the presence of one or more chosen from water, surfactants, pigments, catalysts, alkali silicates and fillers, and curing the low exotherm polyurethane foam, grout or elastomer.

The present invention further provides a solid polyurethane composition made from at least one-polyisocyanate, at least one isocyanate-reactive compound and at least one organic particulate material capable of absorbing heat, optionally one or more chosen from water, surfactants, pigments, catalysts and fillers.

The present invention yet further provides one of an improved reaction injection molding (“RIM”), a spray elastomer or a cast molding process, the improvement involving including a solid polyurethane composition made from at least one polyisocyanate, at least one isocyanate-reactive compound and at least one organic particulate material capable of absorbing heat, optionally one or more chosen from water, surfactants, pigments, catalysts, and fillers.

The inventive foam producing processes may be used in the repair of infrastructure such as buildings, foundations, roads, bridges, highways, sidewalks, tunnels, sewers, manholes, sewage treatment systems, water treatment systems, reservoirs, canals, irrigation ditches, etc. and in the geo-stabilization of mines, caves, wells, bore-holes, ditches, trenches, pits, cracks, fissures, craters, postholes, potholes, sinkholes, wallows, waterholes and the like. The inventive solid polyurethane compositions may be used in such processes as reaction injection molding (“RIM”), elastomeric spraying and cast molding.

The polyurethane foams, grouts and elastomers useful in the processes of the present invention and the inventive solid polyurethanes are prepared by reacting at least one organic polyisocyanate with an isocyanate-reactive compound and an organic particulate material capable of absorbing heat. Suitable polyisocyanates are known to those skilled in the art and include unmodified isocyanates, modified polyisocyanates, and isocyanate prepolymers. Such organic polyisocyanates include aliphatic, cycloaliphatic, araliphatic, aromatic, and heterocyclic polyisocyanates of the type described, for example, by W. Siefken in Justus Liebigs Annalen der Chemie, 562, pages 75 to 136. Examples of such isocyanates include those represented by the formula
Q(NCO)ₙ
in which n is a number from 2-5, preferably 2-3, and Q is an aliphatic hydrocarbon group containing 2-18, preferably 6-10, carbon atoms; a cycloaliphatic hydrocarbon group containing 4-15, preferably 5-10, carbon atoms; an araliphatic hydrocarbon group containing 8-15, preferably 8-13, carbon atoms; or an aromatic hydrocarbon group containing 6-15, preferably 6-13, carbon atoms.

Examples of suitable isocyanates include ethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3- and -1,4-diisocyanate, and mixtures of these isomers; 1-isocyanato-3,3,5-trimethyl-5-isocyanatomethylcyclohexane (isophorone diisocyanate; e.g., German Auslegeschrift 1,202,785 and U.S. Pat. No. 3,401,190); 2,4- and 2,6-hexahydrotoluene diisocyanate and mixtures of these isomers; dicyclohexylmethane-4,4′-diisocyanate (hydrogenated MDI, or HMDI); 1,3- and 1,4-phenylene diisocyanate; 2,4- and 2,6-toluene diisocyanate and mixtures of these isomers (TDI); diphenylmethane-2,4′- and/or -4,4′-diisocyahate (MDI); naphthylene-1,5-diisocyanate; triphenylmethane-4,4′,4″-triisocyanate; polyphenyl-polymethylene-polyisocyanates of the type which may be obtained by condensing aniline with formaldehyde, followed by phosgenation (crude MDI), which are described, for example, in GB 878,430 and GB 848,671; norbornane diisocyanates, such as described in U.S. Pat. No. 3,492,330; m- and p-isocyanatophenyl sulfonylisocyanates of the type described in U.S. Pat. No. 3,454,606; perchlorinated aryl polyisocyanates of the type described, for example, in U.S. Pat. No. 3,227,138; modified polyisocyanates containing carbodiimide groups of the type described in U.S. Pat. No. 3,152,162; modified polyisocyanates containing urethane groups of the type described, for example, in U.S. Pat. Nos. 3,394,164 and 3,644,457; modified polyisocyanates containing allophanate groups of the type described, for example, in GB 994,890, BE 761,616, and NL 7,102,524; modified polyisocyanates containing isocyanurate groups of the type described, for example, in U.S. Pat. No. 3,002,973, German Patentschriften 1,022,789, 1,222,067 and 1,027,394, and German Offenlegungsschriften 1,919,034 and 2,004,048; modified polyisocyanates containing urea groups of the type described in German Patentschrift 1,230,778; polyisocyanates containing biuret groups of the type described, for example, in German Patentschrift 1,101,394, U.S. Pat. Nos. 3,124,605 and 3,201,372, and in GB 889,050; polyisocyanates obtained by telomerization reactions of the type described, for example, in U.S. Pat. No. 3,654,106; polyisocyanates containing ester groups of the type described, for example, in GB 965,474 and GB 1,072,956, in U.S. Pat. No. 3,567,763, and in German Patentschrift 1,231,688; reaction products of the above-mentioned isocyanates with acetals as described in German Patentschrift 1,072,385; and polyisocyanates containing polymeric fatty acid groups of the type described in U.S. Pat. No. 3,455,883. It is also possible to use the isocyanate-containing distillation residues accumulating in the production of isocyanates on a commercial scale, optionally in solution in one or more of the polyisocyanates mentioned above. Those skilled in the art will recognize that it is also possible to use mixtures of the polyisocyanates described above.

In general, it is preferred to use readily available polyisocyanates, such as 2,4- and 2,6-toluene diisocyanates and mixtures of these isomers (TDI); polyphenyl-polymethylene-polyisocyanates of the type obtained by condensing. aniline with formaldehyde, followed by phosgenation (crude MDI); and polyisocyanates containing carbodiimide groups, urethane groups, allophanate groups, isocyanurate groups, urea groups, or biuret groups (modified polyisocyanates).

Isocyanate-terminated prepolymers may also be employed in the preparation of the polyurethane foams, grouts and elastomers used the inventive processes and in the inventive polyurethane solids. Prepolymers may be prepared by reacting an excess of organic polyisocyanate or mixtures thereof with a minor amount of an active hydrogen-containing compound as determined by the well-known Zerewitinoff test, as described by Kohler in Journal of the American Chemical Society, 49, 3181(1927). These compounds and their methods of preparation are well known to those skilled in the art. The use of any one specific active hydrogen compound is not critical; any such compound can be employed in the practice of the present invention.

Suitable isocyanate-reactive compounds include water, polyethers, polyesters, polyacetals, polycarbonates, polyesterethers, polyester carbonates, polythioethers, polyamides, polyesteramides, polysiloxanes, polybutadienes, and polyacetones. Particularly preferred compounds contain 2 to 4 reactive amino or hydroxyl groups.

Hydroxyl-containing polyethers are preferred as the isocyanate-reactive compound. Suitable hydroxyl-containing polyethers can be prepared, for example, by the polymerization of epoxides such as ethylene oxide, propylene oxide, butylene oxide, tetrahydrofuran, styrene oxide, or epichlorohydrin, optionally in the presence of BF₃, or by chemical addition of such epoxides, optionally as mixtures or successively, to starting components containing reactive hydrogen atoms, such as water, alcohols, or amines. Examples of such starting components include ethylene glycol, 1,2- or 1,3-propanediol, 1,2-, 1,3-, or 1,4-butanediol, glycerin, pentaerythritol, 4,4′-dihydroxydiphenylpropane, aniline, 2,4- or 2,6-diaminotoluene, ammonia, ethanolamine, triethanolamine, or ethylene diamine. Polyethers that contain predominantly primary hydroxyl groups (up to about 90% by weight, based on all of the hydroxyl groups in the polyether) are also suitable. Particularly preferred polyethers include polyoxyalkylene polyether polyols, such as polyoxyethylene diol, polyoxypropylene diol, polyoxybutylene diol, and polytetramethylene diol.

Hydroxyl-containing polyesters are also suitable as the isocyanate-reactive compound. Suitable hydroxyl-containing polyesters include reaction products of polyhydric alcohols (preferably diols), optionally with the addition of trihydric alcohols, and polybasic (preferably dibasic) carboxylic acids. Instead of free polycarboxylic acids, the corresponding polycarboxylic acid anhydrides or corresponding polycarboxylic acid esters of lower alcohols or mixtures thereof may be used for preparing the polyesters. The polycarboxylic acids may be aliphatic, cycloaliphatic, aromatic, or heterocyclic and may be substituted, e.g., by halogen atoms, and/or unsaturated. Suitable polycarboxylic acids include succinic acid, adipic acid, suberic acid, azelaic acid, sebacic acid, phthalic acid, isophthalic acid, trimellitic acid, phthalic acid anhydride, tetrahydrophthalic acid anhydride, hexahydrophthalic acid anhydride, tetrachlorophthalic acid anhydride, endo-methylene tetrahydrophthalic acid anhydride, glutaric acid anhydride, maleic acid, maleic acid anhydride, fumaric acid, dimeric and trimeric fatty acids, dimethyl terephthalic, and terephthalic acid bis-glycol esters. Suitable polyhydric alcohols include ethylene glycol, 1,2- and 1,3-propanediol, 1,4- and 2,3-butanediol, 1,6-hexanediol, 1,8-octanediol, neopentyl glycol, 1,3- and 1,4-bis(hydroxymethyl)cyclohexane, 2-methyl-1,3-propanediol, glycerol, 1,2,6-hexanetriol, 1,2,4-butanetriol, trimethylolethane, pentaerythritol, quinitol, mannitol, sorbitol, methyl glycoside, diethylene glycol, triethylene glycol, tetraethylene glycol, polyethylene glycols, dipropylene glycol, polypropylene glycols, dibutylene glycol, and polybutylene glycols. The polyesters may also contain a proportion of carboxyl end groups. Polyesters of lactones, such as ε-caprolactone, or of hydroxycarboxylic acids, such as ω-hydroxycaproic acid, may also be used. Hydrolytically stable polyesters are preferably used to obtain the greatest benefit relative to the hydrolytic stability of the final product.

Preferred polyesters include polyesters obtained from adipic acid or isophthalic acid and straight chained or branched diols, as well as lactone polyesters, preferably those based on caprolactone and diols.

Suitable polyacetals include compounds obtained from the condensation of glycols, such as diethylene glycol, triethylene glycol, 4,4′-dihydroxydiphenylmethane, and hexanediol, with formaldehyde or by the polymerization of cyclic acetals, such as trioxane.

Suitable polycarbonates include those prepared by the reaction of diols, such as 1,3-propanediol, 1,4-butanediol, 1,6-hexanediol, diethylene glycol, triethylene glycol, tetraethylene glycol, or thiodiglycol, with phosgene or diaryl carbonates such as diphenyl carbonate (German Auslegeschriften 1,694,080, 1,915,908, and 2,221,751; German Offenlegungsschrift 2,605,024). Suitable polyester carbonates include those prepared by the reaction of polyester diols, with or without other diols such as 1,3-propanediol, 1,4-butanediol, 1,6-hexanediol, diethylene glycol, triethylene glycol, tetraethylene glycol, or thiodiglycol, with phosgene, cyclic carbonates, or diaryl carbonates such as diphenyl carbonate. Suitable polyester carbonates more generally include compounds such as those disclosed in U.S. Pat. No. 4,430,484.

Suitable polythioethers include the condensation products obtained by the reaction of thiodiglycol, alone or with other glycols, formaldehyde, or amino alcohols. The products obtained are polythio-mixed ethers, polythioether esters, or polythioether ester amides, depending on the components used.

Suitable polyester amides and polyamides include, for example, the predominantly linear condensates prepared from polybasic saturated and unsaturated carboxylic acids or the anhydrides thereof and polyvalent saturated or unsaturated amino alcohols, diamines, polyamines, and mixtures thereof.

Although less preferred, other suitable hydroxyl-containing compounds include polyhydroxyl compounds already containing urethane or urea groups and modified or unmodified natural polyols. Products of addition of alkylene oxides to phenol-formaldehyde resins or to urea-formaldehyde resins are also suitable. Furthermore, amide groups may be introduced into the polyhydroxyl compounds as described, for example, in German Offenlegungsschrift 2,559,372.

General discussions of representative hydroxyl-containing isocyanate-reactive compounds that may be used in the processes of the present invention can be found, for example, in Polyurethanes, Chemistry and Technology by Saunders and Frisch, Interscience Publishers, New York, London, Volume I, 1962, pages 32-42 and pages 44-54, and Volume II, 1964, pages 5-6 and 198-199, and in Kunststoff-Handbuch, Volume VII Vieweg-Hochtlen, Carl-HanserVerlag, Munich, 1966, on pages 45 to 71.

Suitable compounds containing amino groups include the so-called amine-terminated polyethers containing primary or secondary (preferably primary) aromatically or aliphatically (preferably aliphatically) bound amino groups. Compounds containing amino end groups can also be attached to the polyether chain through urethane or ester groups. These amine-terminated polyethers can be prepared by any of several methods known in the art. For example, amine-terminated polyethers can be prepared from polyhydroxyl polyethers (e.g., polypropylene glycol ethers) by a reaction with ammonia in the presence of Raney nickel and hydrogen (BE 634,741). Polyoxyalkylene polyamines can be prepared by a reaction of the corresponding polyol with ammonia and hydrogen in the presence of a nickel, copper, chromium catalyst (U.S. Pat. No. 3,654,370). The preparation of polyethers containing amino end groups by the hydrogenation of cyanoethylated polyoxypropylene ethers is described in German Patentschrift 1,193,671. Other methods for the preparation of polyoxyalkylene (polyether) amines are described in U.S. Pat. Nos. 3,155,728 and 3,236,895 and in FR 1,551,605. FR 1,466,708 discloses the preparation of polyethers containing secondary amino end groups. Also useful are the polyether polyamines described in U.S. Pat. Nos. 4,396,729, 4,433,067, 4,444,910, and 4,530,941.

Relatively high molecular weight polyhydroxy-polyethers suitable for use in the present invention may be converted into the corresponding anthranilic acid esters by reaction with isatoic acid anhydride. Methods for making polyethers containing aromatic amino end groups are disclosed in German Offenlegungsschriften 2,019,432 and 2,619,840 and U.S. Pat. Nos. 3,808,250, 3,975,428, and 4,016,143. Relatively high molecular weight compounds containing amino end groups may also be obtained according to German Offenlegungsschrift 2,546,536 or U.S. Pat. No. 3,865,791 by reacting isocyanate prepolymers based on polyhydroxyl polyethers with hydroxyl-containing enamines, aldimines, or ketimines and hydrolyzing the reaction product.

Aminopolyethers obtained by the hydrolysis of compounds containing isocyanate end groups are also preferred amine-terminated polyethers. For example, in a process disclosed in German Offenlegungsschrift 2,948,419, polyethers containing hydroxyl groups (preferably two or three hydroxyl groups) react with polyisocyanates to form isocyanate prepolymers whose isocyanate groups are then hydrolyzed in a second step to amino groups. Preferred amine-terminated polyethers are prepared by hydrolyzing an isocyanate compound having an isocyanate group content of from 0.5 to 40% by weight. The most preferred polyethers are prepared by first reacting a polyether containing two to four hydroxyl groups with an excess of an aromatic polyisocyanate to form an isocyanate-terminated prepolymer and then converting the isocyanate groups to amino groups by hydrolysis. Processes for the production of useful amine-terminated polyethers using isocyanate hydrolysis techniques are described in U.S. Pat. Nos. 4,386,218, 4,456,730, 4,472,568, 4,501,873, 4,515,923, 4,525,534, 4,540,720, 4,578,500, and 4,565,645, EP 0,097,299, and German Offenlegungsschrift 2,948,419. Similar products are also described in U.S. Pat. Nos. 4,506,039, 4,525,590, 4,532,266, 4,532,317, 4,723,032, 4,724,252, 4,855,504, and 4,931,595.

Other suitable amine-terminated polyethers include aminophenoxy-substituted polyethers described, for example, in U.S. Pat. Nos. 5,091,582 and 4,847,416.

The amine-terminated polyethers useful in the present invention are in many cases mixtures with other isocyanate-reactive compounds having the appropriate molecular weight. These mixtures generally should contain (on a statistical average) two to four isocyanate-reactive amino end groups.

Aminocrotonate-terminated derivatives of polyethers, as well as of other polyols described above, can be prepared from acetoacetate-modified polyethers as described, for example, in U.S. Pat. Nos. 5,066,824, and 5,151,470.

Because infrastructure repairs and geo-stabilization typically occur in locations where the buildup of heat generated by a foam-forming reaction is undesirable and potentially dangerous, and because reaction molding (“RIM”), elastomeric spray and cast molding processes occur in locations that are partially or wholly enclosed and/or poorly ventilated where heat build-up can problematic, e.g., molded castings are commonly made in closed molds where heat accrual can slow production because the mold must be cooled after each process cycle, the organic particulate material used in the present invention should be chosen such that it can undergo a transition involving an endothermic phase change (i.e., a phase change as a result of absorbing heat) at a temperature below the maximum exotherm which the polyurethane solid, foam, grout or elastomer would experience during production in the absence of the particulate material. Particularly preferred in the present invention are the organic particulate materials such as described in U.S. Pat. No. 6,265,457, the entire contents of which are incorporated herein by reference thereto.

The organic particulate material is preferably a solid at ambient temperature and pressure (e.g., 20° C. and 1 atmosphere, respectively). Preferably, the physical transition occurs as a result of the organic particulate material absorbing at least a portion of the heat generated by the reaction thereby resulting in the particulate material melting, dehydrating, and/or sublimating, preferably melting. The organic particulate material may optionally be crystalline. Such crystalline organic particulate materials include crystalline alkyl hydrocarbons, crystalline fatty acids, crystalline fatty acid salts, crystalline fatty acid esters, crystalline olefins, crystalline alcohols, crystalline alicyclic hydrocarbons, crystalline aromatic hydrocarbons, crystalline aromatic acids, crystalline aromatic esters, crystalline aromatic acid salts, crystalline halogenated hydrocarbons, crystalline heterocyclic hydrocarbons, crystalline substituted phenols, crystalline amides, crystalline hydrocarbon ethers and crystalline nitro hydrocarbons.

The size of the organic particulate material is not specifically restricted provided that it does not have a deleterious effect on processing (i.e., the size of the particular material should not result in such an increase in viscosity of the polyurethane that it becomes difficult to meter or otherwise handle). Preferably, the organic particulate material has an average particle size of less than 1000 μm, more preferably in the range of from 1 to 500 μm, most preferably in the range of from 10 to 200 μm. The organic particulate material may have an average particle size in the processes of present invention ranging between any combination of these values, inclusive of the recited values. The organic particulate material may optionally be encapsulated as is known in the art.

The amount of organic particulate material in the polyurethane foam, grout or elastomer is preferably less than 50% by weight, more preferably from 0.5% to 15% by weight and most preferably from 5% to 10% by weight of the polyurethane. The organic particulate material may be present in the compositions and processes of the present invention in an amount ranging between any combination of these values, inclusive of the recited values. The amount of organic particulate material used can be influenced by a number of factors, including the heat capacity of the specific particulate material being used, the maximum exotherm of the polyurethane solid, foam, grout or elastomer being produced with the particulate material and the viscosity of the reaction, especially at higher loadings of particulate material.

As stated above, the preferred organic particulate material has a melting point below the maximum temperature reached by the polyurethane solid, foam, grout or elastomer during production. Thus, as heat is liberated during the reaction, a portion thereof, instead of raising the exotherm of the polyurethane, is absorbed by the particulate material, resulting in melting of the particulate material. Because the particulate material is substantially uniformly distributed throughout the polyurethane solid, foam, grout or elastomer, the result is an overall lowering of the maximum exotherm experienced by the polyurethane. This dramatically improves the safety of polyurethane foam, grout or elastomer production thus allowing its use in partially enclosed and/or poorly ventilated spaces such as buildings, foundations, roads, bridges, highways, sidewalks, tunnels, manholes, sewers, sewage treatment systems, water treatment systems, reservoirs, canals, irrigation ditches, mines, caves, wells, bore-holes, ditches, trenches, pits, cracks, fissures, craters, postholes, potholes, sinkholes, wallows, waterholes and the like. As the polyurethane cools after production, the organic particulate material will resolidify. The inventive solid polyurethane also provides for safer, quicker and less problematic use in such processes as reaction injection molding (“RIM”), elastomeric spraying and cast molding.

The organic particulate material is preferably an organic polymer, more preferably a thermoplastic material. Non-limiting examples of useful thermoplastic polymers include acrylonitrile butadiene styrene (“ABS”),acrylic, celluloid, cellulose acetate, ethylene-vinyl acetate (“EVA”), ethylene vinyl alcohol (“EVAL”), fluoroplastics such as polytetrafluoroethyelene (“PTFE”), tetrafluorethylene-perfluorpropylene (“FEP”), perfluoroalkoxy (“PFA”), chlorotrifluoroethylene (“CTFE”), ethylene-chlorotrifluoro-ethylene (“ECTFE”) and ethylenetetrafluoroethylene (“ETFE”), ionomers, liquid crystal polymer (“LCP”), polyacetal (“POM”), polyacrylates (acrylic), polyacrylonitrile (“PAN”), polyamide (“PA”), polyamide-imide (“PAI”), polyaryletherketone (“PAEK”), polybutadiene (“PBD”), polybutylene (“PB”), polybutylene terephthalate (“PBT”), polyethylene terephthalate (“PET”), polycyclohexylene dimethylene terephthalate (“PCT”), polycarbonate (“PC”), polyhydroxyalkanoates (“PHA”s), polyketone (“PK”), polyester, polyethylene (“PE”), polyetheretherketone (“PEEK”), polyetherimide (“PEI”), polyethersulfone (“PES”), polyethylenechlorinates (“PEC”), polyiniide (“PI”), polylactic acid (“PLA”), polymethylpentene (“PMP”), polyphenylene oxide (“PPO”), polyphenylene sulfide (“PPS”), polyphthalamide (“PPA”), polypropylene (“PP”), polystyrene (“PS”), polysulfone (“PSU”), polyvinyl chloride (“PVC”), thermoplastic polyurethane (“TPU”) and mixtures thereof. More preferably, the particulate material is chosen from polyethylene, polypropylene and mixtures thereof. Among the most preferred are particulate materials chosen from high density polyethylene (HDPE) and copolymers of ethylene and butene-1. Non-limiting examples of other useful organic materials may be chosen from paraffins, fatty acids, alcohols, tetradecanoic acid, myristamide, salts of fatty acids (e.g., calcium stearate (melting point 180° C.), zinc stearate (melting point 130° C.), zinc laurate (melting point 130° C.) and the like).

Any suitable aqueous solution of an alkali metal silicate, preferably containing from 20-70% by weight of the alkali metal silicate, such as, for example, sodium silicate, potassium silicate, lithium silicate or the like may be included in the polyurethane foams used in the some embodiments of the inventive processes. Such aqueous silicates are commonly referred to as “waterglass.” It is also possible to use crude commercial-grade solutions which can additionally contain, for example, calcium silicate, magnesium silicate, borates and aluminates. The M₂O:SiO₂ ratio is not critical and can vary within the usual limits, preferably amounting to 4-0.2. M refers to the alkali metal. Preferably, sodium silicate with a molar ratio of Na₂O:SiO₂ between 1:1.6 and 1:3.3 is used. It is preferred to use 32 to 54% silicate solutions which, only if made sufficiently alkaline, have a viscosity of less than 500 poises at room temperature which is the limit required to ensure problem free processing. Although ammonium silicate solutions may also be used, they are less preferred. The solutions can either be genuine solutions or colloidal solutions.

The choice of the concentration of the aqueous silicate solution depends upon the required end product. Compact or closed-cell foam materials are preferably prepared with concentrated silicate solutions which, if necessary, are adjusted to low viscosity by the addition of alkali hydroxide. It is possible in this way to prepare 40% to 70% by weight solutions. On the other hand, 20% to 40% by weight silicate solutions are preferably used for the production of open-cell lightweight foams to obtain low viscosities, sufficiently long reaction times and low densities. Even in cases where finely divided inorganic fillers are used in relatively large quantities, 20% to 45% by weight silicate solutions are preferred.

It is also possible to make the silicate solution in situ by using a combination of solid alkali metal silicate and water.

Other suitable additives which may optionally be included in the compositions and processes of the present invention include, for example, stabilizers, catalysts, cell regulators, reaction inhibitors, flame retardants, plasticizers, pigments, fillers, etc.

Foam stabilizers which may be considered suitable for use in the inventive processes include, for example, polyether siloxanes, and preferably those which are insoluble in water. Compounds such as these are generally of such a structure that copolymers of ethylene oxide and propylene oxide are attached to a polydimethylsiloxane residue. Such foam stabilizers are described in, for example, U.S. Pat. Nos. 2,834,748, 2,917,480 and 3,629,308.

Catalysts suitable for the present invention include those which are known in the art. These catalysts include, for example, tertiary amines, such as triethylamine, tributylamine, N-methylmorpholine, N-ethylmorpholine, N,N,N′,N′-tetramethylethylenediamine, pentamethyl-diethylenetriamine and higher homologues (as described in, for example, DE-A 2,624,527 and 2,624,528), 1,4-diazabicyclo(2.2.2)octane, N-methyl-N′-dimethyl-aminoethylpiperazine, bis-(dimethylaminoalkyl)piperazines, N,N-dimethylbenzylamine, N,N-dimethylcyclohexylamine, N,N-diethyl-benzylamine, bis-(N,N-diethylaminoethyl) adipate, N,N,N′,N′-tetramethyl-1,3-butanediamine, N,N-dimethyl-p-phenylethylamine, 1,2-dimethylinidazole, 2-methylimidazole, monocyclic and bicyclic amines together with bis-(dialkylamino)alkyl ethers, such as 2,2-bis-(dimethylaminoethyl) ether.

Other suitable catalysts include, for example, organometallic compounds, and particularly, organotin compounds. Organotin compounds which may be considered suitable include those organotin compounds containing sulfur. Such catalysts include, for example, di-n-octyltin mercaptide. Other types of suitable organotin catalysts include, preferably tin(II) salts of carboxylic acids such as, for example, tin(l) acetate, tin(II) octoate, tin(II) ethylhexoate and/or tin(II) laurate, and tin(IV) compounds such as, for example, dibutyltin oxide, dibutyltin dichloride, dibutyltin diacetate, dibutyltin dilaurate, dibutyltin maleate and/or dioctyltin diacetate.

Further examples of suitable additives, which may optionally be included can be found in Kunststoff-Handbuch, volume VII, edited by Vieweg & Hochtlen, Carl Hanser Verlag, Munich 1993, 3rd Ed., pp. 104 to 127, for example. The relevant details concerning the use and mode of action of these additives are set forth therein.

The processes of the present invention may be used for repairing infrastructure such as buildings, foundations, roads, bridges, highways, sidewalks, manholes, tunnels, sewers, sewage treatment systems, water treatment systems, reservoirs, canals, irrigation ditches, etc. These inventive processes may also be used in the geo-stabilization of mines, caves, wells, bore-holes, ditches, trenches, pits, cracks, fissures, craters, postholes, potholes, sinkholes, wallows, waterholes and the like.

The inventive processes may take a variety of forms. As an example, bags may be filled with the polyurethane-forming materials; the bags placed behind walls of a building; and the inventive process carried out to stabiilze/ reinforce the walls. Another form of the invention may involve underwater repair of infrastructure with a polyurethane-forming grout where the surrounding water serves as the isocyanate-reactive material.

The inventive solid polyurethane compositions are suitable for use in reaction injection molding (“RIM”) processes such as those disclosed e.g., in U.S. Pat. Nos. 6,765,080; 6,057,416; 5,739,253; 5,688,590; 5,686,042; 5,502,150; 5,137,966; and 4,581,386. The inventive solid polyurethane compositions are also useful in polyurethane spray processes such as those described e.g., in U.S. Pat. Nos. 5,723,194; 6,632,875; and 6,669,407. The solid polyurethane compositions of the present invention may also find appilcation in cast molding processes such as those disclosed in e.g., U.S. Pat. Nos. 6,841,115; 6,642,341; 5,611,976; 5,464,920; and4,720,519.

### EXAMPLES

The present invention is further illustrated, but is not to be limited, by the following examples, in which all quantities given in “parts” and “percents” are understood to be by weight, unless otherwise indicated. The following materials were used in preparing the polyurethane foams and solids of the examples:
Polyol A a 43 wt. % solids polymer polyol having a hydroxyl number of about 18.5, in which the solids are a (63.5%) styrene (36%) acrylonitrile mixture polymerized in situ in a base polyol having a hydroxyl number of about 36 prepared by KOH-catalyzed alkoxylation of glycerin with a block of propylene oxide (80 wt. % of the total oxide) followed by a block of ethylene oxide (20 wt. % of the total oxide);
Polyol B a polyether polyol having a molecular weight of 6,000 and a functionality of 3.0;
Polyol C polyether polyols based on ethylene diamine and propylene oxide (630 OH No.);

Polyol D a propoxylated triol based on glycerine having a hydroxyl number of from about 445-495 mg KOH/g;
Polyol E a filled polyol (20% by weight solids (polyurea)) based on glycerin, propylene oxide, and ethylene oxide (17% by weight) with a hydroxyl number of about 28 mg KOH/g;
Polyol F a glycerine-initiated polyoxypropylated triol of nominal 700 Da molecular weight;
Polyol G a 4,200-molecular-weight polypropylene oxide-based triol, having a hydroxyl number 41 mg KOH/g;
Polyol H an ethylene diamine-based polyether polyol having a hydroxyl number of about 770 mg KOH/g;
Polyol I poly (oxypropylene) tetraol derivative of pentaerythritol available as PLURACOL PEP 450 from BASF;
Polyamine a difunctional, primary amine with average molecular weight of about 2000 available as JEFFAMINE D-2000 from Huntsman;
DETDA diethyltoluenediamine;
TEOA triethanolamine;
TMEDA tetramethylethylenediamine;
Catalyst A an amine catalyst commercially available as NIAX Catalyst A-1 from OSi Specialties SA;
Catalyst B dimethyl benzylamine;
Catalyst C dibutyltin dilaurate, commercially available as DABCO T-12 from Air Products;
Stabilizer TEGOSTAB B-8421, commercially available from Goldschmidt AG;
Chain extender N,N′-dialkylamino-diphenyl-methane available from Dorf-Ketal Chemical as UNILINK 4200;
Light stabilizer A a hindered trialkylamine available as TINUVIN 292 from Ciba Specialty Chemicals;
Light stabilizer B reaction product of beta-(3-(2H-benzotriazol-2-YL-4-hydroxy-5-tert-butylphenyl)proprionic acid, methyl ester and ethylene glycol 300), available from Ciba Specialty Chemicals as TINUVIN 1130;
Antioxidant isooctyl 3-(3,5-di-tert-butyl-4-hydroxyphenyl) propionate, available as IRGANOX 1135 from Ciba Specialty Chemicals;
Adhesion promoter 3-glycidoxypropyl-trimethoxysilane, available from GE Advance Materials as SILQUEST A-187;
Alkali silicate a 2.0 weight ratio sodium silicate, 44.1% solution in water;
Organic particulate A high density polyethylene (HDPE) particles available as VISTAMER HD-1000 from Composite Particles, Inc;
Organic particulate B a copolymer of ethylene and butene-1;
Organic particulate C a copolymer of ethylene and butane-1 powder available as XANATHANE EMT E5000 from Woodbridge Foam Corporation;
Surfactant a non-ionic surfactant available from Air Products as SURFYNOL TG;
Filler A an elastomeric essentially linear hydroxyl polyurethane powder available as DESMOMELT VP KA-8702 from Bayer MaterialScience;
Filler B artic mist talc from Luzenac;
Drying agent a zeolite paste dispersion in castor oil available as BAYLITH L Paste from Bayer MaterialScience;
Isocyanate A a polymeric diphenylmethane diisocyanate having an NCO content of 30.6% and a Brookfield viscosity at 25° C. of 700 mPa·s;
Isocyanate B a polymeric diphenylmethane diisocyanate having an NCO group content of about 31.5%, and a viscosity of about 196 mPa·s at 25° C.;
Isocyanate C an isocyanate-terminated (MDI) polyether prepolymer; NCO Cont. 16.5%; viscosity 600 mPa·s at 25° C.; and
Isocyanate D a modified monomeric 4,4-diphenylmethane diisocyanate (mMDI) having an NCO content 29.5%, a viscosity of 50 mPa·s at 25° C.

Foams were made by combining the components given below in Table I and reacting the mixture with Isocyanate A at a 1:1 ratio.

TABLE I

| Component | Ex. C-1 (%) | Ex. 2 (%) | Ex. 3 (%) |
|---|---|---|---|
| Polyol A | 27.80 | 27.80 | 27.80 |
| Polyol B | 13.00 | 13.00 | 13.00 |
| Polyol C | 50.00 | 50.00 | 50.00 |
| DETDA | 5.00 | 5.00 | 5.00 |
| TEOA | 3.50 | 3.50 | 3.50 |
| Catalyst A | 0.50 | 0.50 | 0.50 |
| Organic particulate A | — | 5.0 | 10.0 |
| Water | 0.20 | 0.20 | 0.20 |

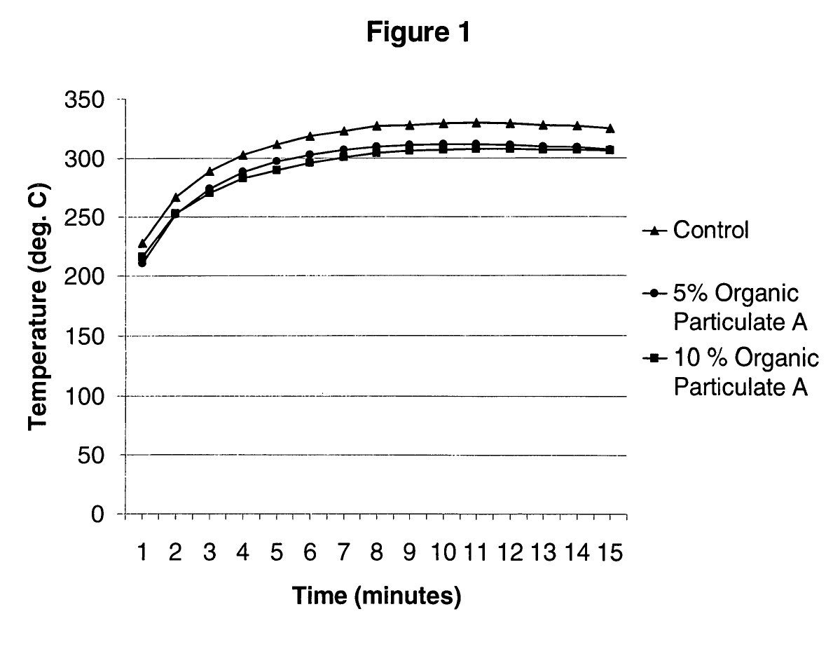

Table II below summarizes the foam core temperature measured from the time of combining the components of Table I with Isocyanate A. FIG. 1 graphically presents these data.

TABLE II

| Time | | | |
|---|---|---|---|
| (min.) | C-1 (° C.) | Ex. 2 (° C.) | Ex. 3 (° C.) |
| 1 | 228 | 211 | 216 |
| 2 | 267 | 252 | 253 |
| 3 | 289 | 274 | 270 |
| 4 | 303 | 288 | 283 |
| 5 | 312 | 297 | 290 |
| 6 | 319 | 303 | 296 |
| 7 | 323 | 307 | 301 |
| 8 | 327 | 310 | 304 |
| 9 | 328 | 311 | 306 |
| 10 | 329 | 312 | 307 |
| 11 | 330 | 312 | 308 |
| 12 | 329 | 311 | 308 |
| 13 | 328 | 310 | 307 |
| 14 | 327 | 309 | 307 |
| 15 | 325 | 307 | 306 |

Water blown foams were made by combining the components in Table III and then adding the mixture to Isocyanate B at a ratio of 91/100 (Ex. C-4, Ex. 5 and Ex. 6) or at a ratio of 100/100 (Ex. C-7, Ex. 8 and Ex. 9).

TABLE III

| | Ex. C-4 | Ex. 5 | Ex. 6 | Ex. C-7 | Ex. 8 | Ex. 9 |
|---|---|---|---|---|---|---|
| Component | (%) | (%) | (%) | (%) | (%) | (%) |
| Polyol D | 37.81 | 37.81 | 37.81 | 79.6 | 79.6 | 79.6 |
| Polyol E | 55.72 | 55.72 | 55.72 | — | — | — |
| Stabilizer | 1.43 | 1.43 | 1.43 | — | — | — |
| TMEDA | 0.14 | 0.14 | 0.14 | — | — | — |
| Catalyst B | 1.39 | 1.39 | 1.39 | — | — | — |
| Catalyst C | 0.5 | 0.5 | 0.5 | 0.5 | 0.5 | 0.5 |
| Organic particulate B | — | 5.0 | 10.0 | — | 5.0 | 10.0 |
| Alkali Silicate | — | — | — | 19.9 | 19.9 | 19.9 |
| Water | 3 | 3 | 3 | — | — | — |

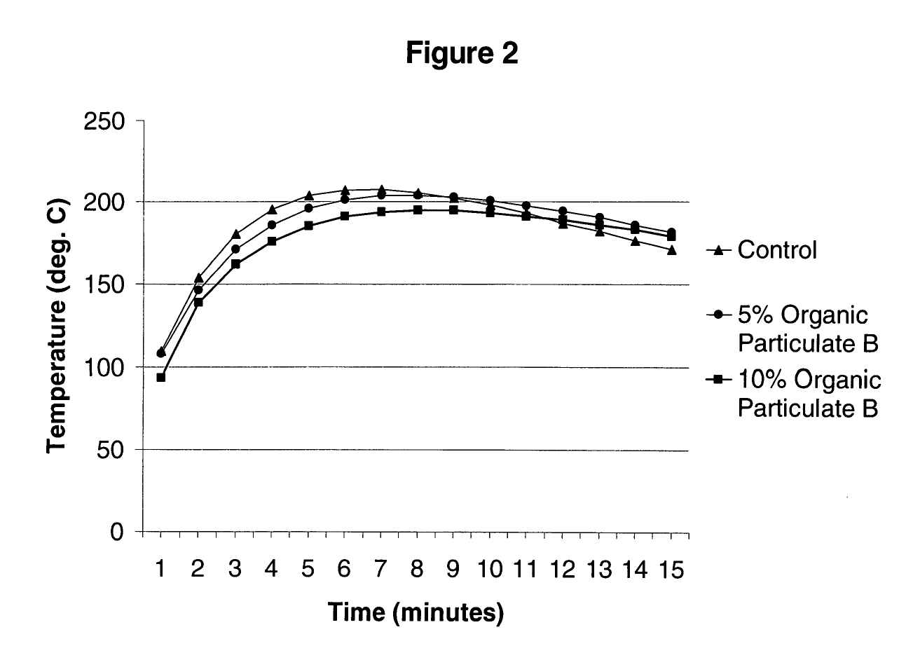

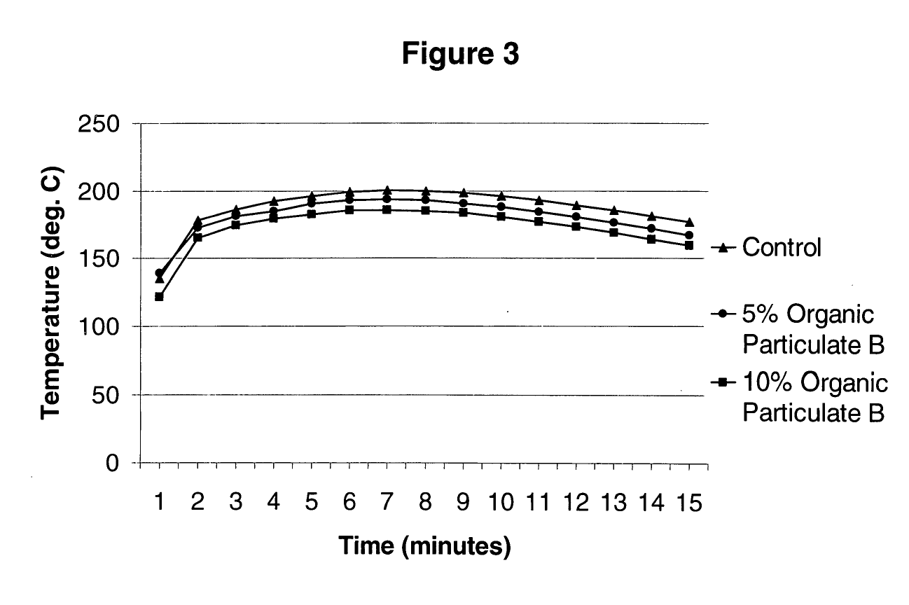

Table IV summarizes the foam core temperature measured from the time of combining the components of Table I with Isocyanate B. FIG. 2 (Examples C-4, 5 and 6) and FIG. 3 (Examples C-7, 8 and 9) graphically present these data.

TABLE IV

| Time | | | | | | |
|---|---|---|---|---|---|---|
| (min.) | C-4 (° C.) | Ex. 5 (° C.) | Ex. 6 (° C.) | C-7(° C.) | Ex. 8 (° C.) | Ex. 9 (° C.) |
| 1 | 109 | 108 | 93 | 135 | 139 | 122 |
| 2 | 154 | 146 | 139 | 178 | 173 | 165 |
| 3 | 180 | 171 | 162 | 186 | 181 | 174 |
| 4 | 195 | 186 | 176 | 192 | 185 | 179 |
| 5 | 204 | 196 | 185 | 196 | 190 | 183 |
| 6 | 207 | 201 | 191 | 199 | 193 | 185 |
| 7 | 207 | 204 | 194 | 201 | 194 | 186 |
| 8 | 206 | 204 | 195 | 200 | 193 | 185 |
| 9 | 202 | 203 | 195 | 199 | 191 | 183 |
| 10 | 198 | 201 | 193 | 196 | 188 | 181 |
| 11 | 193 | 198 | 191 | 193 | 184 | 177 |
| 12 | 187 | 194 | 189 | 189 | 181 | 173 |
| 13 | 182 | 190 | 186 | 185 | 176 | 169 |
| 14 | 176 | 186 | 183 | 181 | 172 | 164 |
| 15 | 171 | 181 | 179 | 177 | 167 | 160 |

### Examples C10, 11 and 12

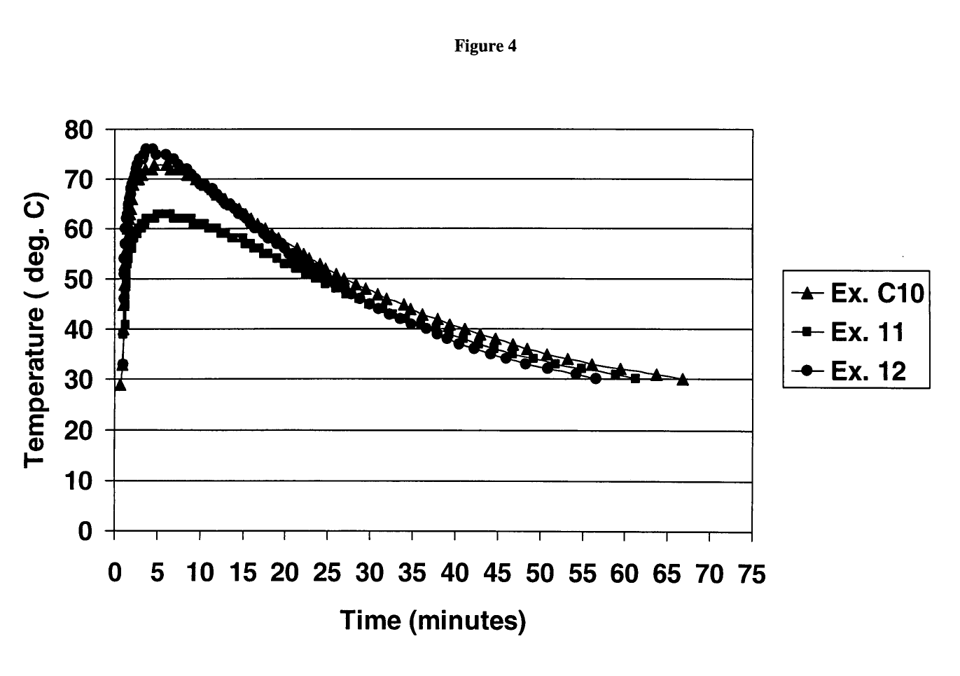

The non-isocyanate components where mixed in a flask for one min at 25,000 rpm. Filler (if required) was hand mixed until the mixture was homogeneous. The isocyanate was added and mixed 30 second at 20,000 rpm. A portion of the mixture (100 g) was transferred to a small plastic cup and a thermocouple was inserted. The cup was covered with a lid and the core temperature was measured with a Fisher brand thermometer and a stainless steel probe made by Control Company Thermocouple until sample returned to 30° C. A plot of the exotherm is presented in FIG. 4.

TABLE V

| | Ex. C10 | Ex. 11 | Ex. 12 |
|---|---|---|---|
| Polyamine | 38.2 | 38.2 | 38.2 |
| Chain extender | 56.3 | 56.3 | 56.3 |
| TiO2 | 10 | 10 | 10 |
| Light stabilizer A | 0.5 | 0.5 | 0.5 |
| Light stabilizer B | 0.5 | 0.5 | 0.5 |
| Antioxidant | 1.0 | 1.0 | 1.0 |
| Adhesion promoter | 0.5 | 0.5 | 0.5 |
| Filler A | 0.0 | 50.0 | 0 |
| Filler B | 0.0 | 0.0 | 50.0 |
| Isocyanate C | 114 | 114 | 114 |

TABLE VI

| | Wt. % |
|---|---|
| Polyol F | 34.93 |
| Polyol G | 19.96 |
| Polyol H | 4.99 |
| Polyol I | 29.94 |
| Drying agent | 9.98 |
| Surfactant | 0.20 |
| Isocyanate D | 77.5 |

### Examples C13 and 14

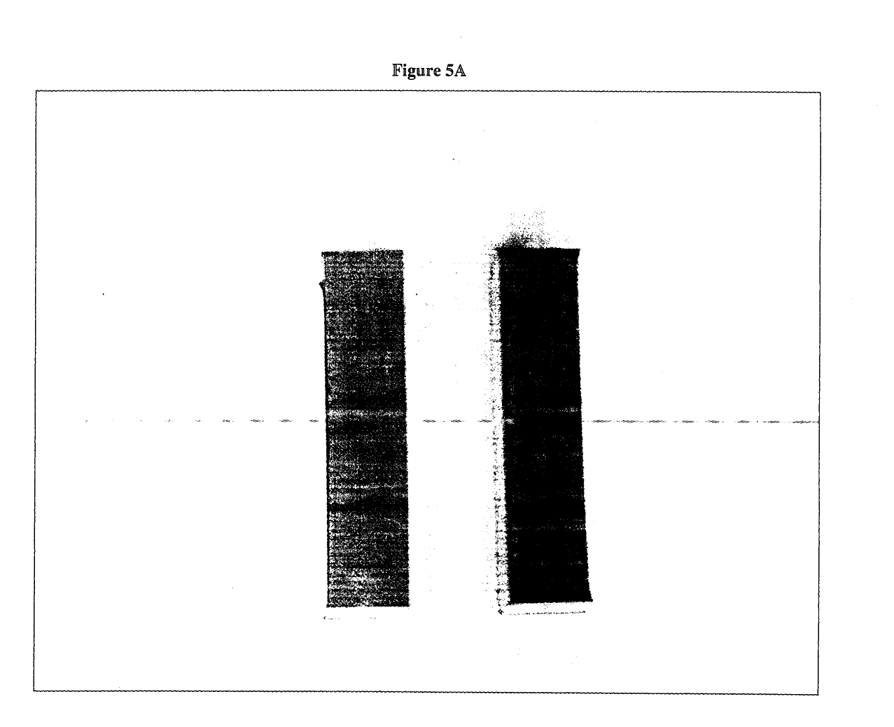

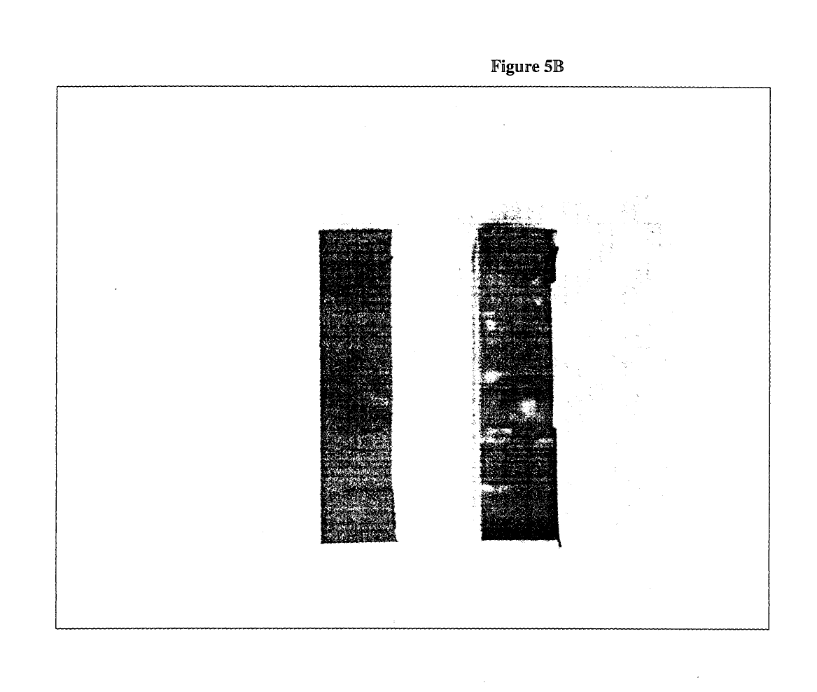

Formulations with and without 20 wt. % of organic particulate C were prepared as detailed above in Table VI and reaction injection molded. Photographs of the finished part made without and with the organic particulate are shown in FIGS. 5A and 5B, respectively. The peak exotherm for the formulation without organic particulate (Ex. C13) was observed at 8 minutes, 30 seconds at a temperature of 282° F. The peak exotherm for the formulation with organic particulate (Ex. 14) was observed at 11 minutes at a temperature of 256.8° F.

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

What is claimed is:

1. A solid polyurethane composition comprising,
at least one polyisocyanate,
at least one isocyanate-reactive compound, and
at least one organic particulate material capable of absorbing heat,
optionally, one or more of water, surfactants, pigments, catalysts, and fillers.

2. The solid polyurethane according to claim 1, wherein the at least one polyisocyanate is selected from the group consisting of ethylene diisocyanate, 1,4-tetramethylene diisocyanate, 1,6-hexamethylene diisocyanate, 1,12-dodecane diisocyanate, cyclobutane-1,3-diisocyanate, cyclohexane-1,3-and -1,4-diisocyanate, 1-isocyanato-3,3,5-trimethyl-5-isocyanatomethyl-cyclohexane (isophorone diisocyanate), 2,4- and 2,6-hexahydrotoluene diisocyanate, dicyclohexylmethane-4,4′-diisocyanate (hydrogenated MDI, or HMDI), 1,3- and 1,4-phenylene diisocyanate, 2,4- and 2,6-toluene diisocyanate (TDI), diphenylmethane-2,4′- and/or -4,4′-diisocyanate (MDI), polymeric diphenylmethane diisocyanate (PMDI), naphthylene-1,5-diisocyanate, triphenyl-methane-4,4′,4″-triisocyanate, polyphenyl-polymethylene-polyisocyanates (crude MDI), norbornane diisocyanates, m- and p-isocyanatophenyl sulfonylisocyanates, perchlorinated aryl polyisocyanates, carbodiimide-modified polyisocyanates, urethane-modified polyisocyanates, allophanate-modified polyisocyanates, isocyanurate-modified polyisocyanates, urea-modified polyisocyanates, biuret containing polyisocyanates and isocyanate-terminated prepolymers.

3. The solid polyurethane according to claim 1, wherein the at least one isocyanate-reactive compound is selected from the group consisting of water, polyethers, polyesters, polyacetals, polycarbonates, polyesterethers, polyester carbonates, polythioethers, polyamides, polyesteramides, polysiloxanes, polybutadienes and polyacetones.

4. The solid polyurethane according to claim 1, wherein the organic particulate material is selected from the group consisting of acrylonitrile butadiene styrene, acrylic, celluloid, cellulose acetate, ethylene-vinyl acetate, ethylene vinyl alcohol, polytetrafluoroethyelene, tetrafluorethylene-perfluorpropylene, perfluoroalkoxy, chlorotrifluoroethylene, ethylene-chlorotrifluoro-ethylene, ethylenetetrafluoroethylene, ionomers, liquid crystal polymer, polyacetal, polyacrylates, polyacrylonitrile, polyamide, polyamide-imide, polyaryletherketone, polybutadiene, polybutylene, polybutylene terephthalate, polyethylene terephthalate, polycyclohexylene dimethylene terephthalate, polycarbonate, polyhydroxyalkanoates, polyketone, polyester, polyethylene, polyetheretherketone, polyetherimide, polyethersulfone, polyethylenechlorinates, polyimide, polylactic acid, polymethylpentene, polyphenylene oxide, polyphenylene sulfide, polyphthalamide, polypropylene, polystyrene, polysulfone, polyvinyl chloride, thermoplastic polyurethane, crystalline alkyl hydrocarbons, crystalline fatty acids, crystalline fatty acid salts, crystalline fatty acid esters, crystalline olefins, crystalline alcohols, crystalline alicyclic hydrocarbons, crystalline aromatic hydrocarbons, crystalline aromatic acids, crystalline aromatic esters, crystalline aromatic acid salts, crystalline halogenated hydrocarbons, crystalline heterocyclic hydrocarbons, crystalline substituted phenols, crystalline amides, crystalline hydrocarbon ethers, crystalline nitro hydrocarbons and mixtures thereof.

5. The solid polyurethane according to claim 1, wherein the organic particulate material has an average particle size of less than about 1000 μm.

6. The solid polyurethane according to claim 1, wherein the organic particulate material has an average particle size of from about 1 to about 500 μm.

7. The solid polyurethane according to claim 1, wherein the organic particulate material has an average particle size of from about 10 to about 200 μm.

8. In one of a reaction injection molding (“RIM”) process, a spray elastomeric process or a cast molding process, the improvement comprising including a solid polyurethane composition comprising at least one polyisocyanate, at least one isocyanate-reactive compound and at least one organic particulate material capable of absorbing heat, optionally one or more of water, surfactants, pigments, catalysts, and fillers.

9. The one of a reaction injection molding (“RIM”) process, a spray elastomeric process or a cast molding process according to claim 8, wherein the at least one polyisocyanate is selected from the group consisting of ethylene diisocyanate, 1,4-tetramethylene diisocyanate, 1,6-hexamethylene diisocyanate, 1,12-dodecane diisocyanate, cyclobutane-1,3-diisocyanate, cyclohexane-1,3-and -1,4-diisocyanate, 1-isocyanato-3,3,5-trimethyl-5-isocyanatomethyl-cyclohexane (isophorone diisocyanate), 2,4- and 2,6-hexahydrotoluene diisocyanate, dicyclohexylmethane-4,4′-diisocyanate (hydrogenated MDI, or HMDI), 1,3- and 1,4-phenylene diisocyanate, 2,4- and 2,6-toluene diisocyanate (TDI), diphenylmethane-2,4′- and/or -4,4′-diisocyanate (MDI), polymeric diphenylmethane diisocyanate (PMDI), naphthylene-1,5-diisocyanate, triphenyl-methane-4,4′,4″-triisocyanate, polyphenyl-polymethylene-polyisocyanates (crude MDI), norbornane diisocyanates, m- and p-isocyanatophenyl sulfonylisocyanates, perchlorinated aryl polyisocyanates, carbodiimide-modified polyisocyanates, urethane-modified polyisocyanates, allophanate-modified polyisocyanates, isocyanurate-modified polyisocyanates, urea-modified polyisocyanates, biuret containing polyisocyanates and isocyanate-terminated prepolymers.

10. The one of a reaction injection molding (“RIM”) process, a spray elastomeric process or a cast molding process according to claim 8, wherein the at least one isocyanate-reactive compound is selected from the group consisting of water, polyethers, polyesters, polyacetals, polycarbonates, polyesterethers, polyester carbonates, polythioethers, polyamides, polyesteramides, polysiloxanes, polybutadienes and polyacetones.

11. The one of a reaction injection molding (“RIM”) process, a spray elastomeric process or a cast molding process according to claim 8, wherein the organic particulate material is selected from the group consisting of acrylonitrile butadiene styrene, acrylic, celluloid, cellulose acetate, ethylene-vinyl acetate, ethylene vinyl alcohol, polytetrafluoroethyelene, tetrafluorethylene-perfluorpropylene, perfluoroalkoxy, chlorotrifluoroethylene, ethylene-chlorotrifluoro-ethylene, ethylenetetrafluoroethylene, ionomers, liquid crystal polymer, polyacetal, polyacrylates, polyacrylonitrile, polyamide, polyamide-imide, polyaryletherketone, polybutadiene, polybutylene, polybutylene terephthalate, polyethylene terephthalate, polycyclohexylene dimethylene terephthalate, polycarbonate, polyhydroxyalkanoates, polyketone, polyester, polyethylene, polyetheretherketone, polyetherimide, polyethersulfone, polyethylenechlorinates, polyimide, polylactic acid, polymethylpentene, polyphenylene oxide, polyphenylene sulfide, polyphthalamide, polypropylene, polystyrene, polysulfone, polyvinyl chloride, thermoplastic polyurethane, crystalline alkyl hydrocarbons, crystalline fatty acids, crystalline fatty acid salts, crystalline fatty acid esters, crystalline olefins, crystalline alcohols, crystalline alicyclic hydrocarbons, crystalline aromatic hydrocarbons, crystalline aromatic acids, crystalline aromatic esters, crystalline aromatic acid salts, crystalline halogenated hydrocarbons, crystalline heterocyclic hydrocarbons, crystalline substituted phenols, crystalline amides, crystalline hydrocarbon ethers, crystalline nitro hydrocarbons and mixtures thereof.

12. The one of a reaction injection molding (“RIM”) process, a spray elastomeric process or a cast molding process according to claim 8, wherein the organic particulate material has an average particle size of less than about 1000 μm.

13. The one of a reaction injection molding (“RIM”) process, a spray elastomeric process or a cast molding process according to claim 8, wherein the organic particulate material has an average particle size of from about 1 μm to about 500 μm.

14. The one of a reaction injection molding (“RIM”) process, a spray elastomeric process or a cast molding process according to claim 8, wherein the organic particulate material has an average particle size of from about 10 μm to about 200 μm.
